(19) United States
(12) Patent Application Publication
(10) Pub. No.: US 2026/0244579 A1
(43) Pub. Date: Aug. 20, 2026

(54) UNIFIED MEMORY PROTECTION TABLE EXTENSION (MPTE) FOR REDUCED INSTRUCTION SET COMPUTER (RISC) DEVICES

(71) Applicant: QUALCOMM Incorporated, San Diego, CA (US)

(72) Inventors: Andrew DELLOW, Box (GB); Eckhard DELFS, Nürnberg (DE)

(21) Appl. No.: 19/234,051

(22) Filed: Jun. 10, 2025

Related U.S. Application Data
(60) Provisional application No. 63/759,825, filed on Feb. 18, 2025.

(51) Int. Cl. G06F 12/14

(52) U.S. Cl. CPC G06F 12/1483; G06F 12/1491

(57) ABSTRACT

A method for enhanced unified memory protection table operation is described. The method includes performing, during physical memory access, a table walk to identify a leaf-node containing permissions for supervisor domains (SDs) corresponding to a physical memory address space. The method also includes accessing the leaf-node to determine an access control permissions field of the leaf-nod. The method further includes performing a look-up to determine access permissions for the supervisor domains from a set of programmable registers according to an identification (ID) value from the access control permissions field of the leaf-node.

### CROSS-REFERENCE TO RELATED APPLICATION

The present application claims the benefit of U.S. Provisional Patent Application No. 63/759,825, filed on Feb. 18, 2025, and titled “UNIFIED MEMORY PROTECTION TABLE EXTENSION (MPTE) FOR REDUCED INSTRUCTION SET COMPUTER (RISC) DEVICES,” the disclosure of which is expressly incorporated by reference in its entirety.

### BACKGROUND

### Field of the Disclosure

Aspects of the present disclosure relate to computer devices, and more specifically to techniques for managing one or more memory protection tables (MPTs) for reduced instruction set computer (RISC) devices.

### BACKGROUND

RISC-V is an open-source instruction set architecture (ISA) used for the development of devices (e.g., such as processors) targeting a variety of end-user applications. The ISA describes how software will control the processor's hardware. The RISC-V ISA is considered a fifth generation (V) of processors based on reduced instruction set computer (RISC) principles. The RISC is designed to simplify individual instructions given to a processor to accomplish tasks. One of the key operational concepts of the RISC processor is that each instruction performs only one function (e.g., copy a value from a memory to a register).

RISC-V provides high performance and economic efficiency by significantly reducing the area of a chip and reducing power consumption to less than half while providing similar performance compared to similar computing devices. Many implementations of RISC-V are available, both as open-source cores and as commercial products. Enhancements of a unified memory protection table (MPT) for RISC-V devices is desired.

### SUMMARY

A method for enhanced unified memory protection table operation is described. The method includes performing, during physical memory access, a table walk to identify a leaf-node containing permissions for supervisor domains (SDs) corresponding to a physical memory address space. The method also includes accessing the leaf-node to determine an access control permissions field of the leaf-node. The method further includes performing a look-up to determine access permissions for the supervisor domains from a set of programmable registers according to an identification (ID) value from the access control permissions field of the leaf-node.

A non-transitory computer-readable medium having program code recorded thereon for enhanced unified memory protection table operation is described. The program code being is executed by a processor. The non-transitory computer-readable medium includes program code to perform, during physical memory access, a table walk to identify a leaf-node containing permissions for supervisor domains (SDs) corresponding to a physical memory address space. The non-transitory computer-readable medium also includes program code to access the leaf-node to determine an access control permissions field of the leaf-node. The non-transitory computer-readable medium further includes program code to perform a look-up to determine access permissions for the supervisor domains from a set of programmable registers according to an identification (ID) value from the access control permissions field of the leaf-node.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following description taken in conjunction with the accompanying drawings.

FIG. 1 is a block diagram illustrating a reduced instruction set computer (RISC) system including at least one processor and at least one memory utilizing an enhanced, unified memory protection table, in accordance with various aspects of the present disclosure.

FIG. 2 depicts example multiple supervisor domains (SDs) associated with different memory regions of at least one memory and including an enhanced, unified memory protection table (MPT), in accordance with various aspects of the present disclosure.

FIG. 3 depicts example first and second M-mode MPT registers to enable an enhanced, unified memory protection table (MPT), in accordance with various aspects of the present disclosure.

FIG. 4 is a block diagram illustrating a leaf-encoded M-mode enhanced, memory protection table entry (MPTE) format, in accordance with various aspects of the present disclosure.

FIG. 5 is a block diagram further illustrating the second M-mode MPT register of FIG. 3, to control access of an enhanced, machine-level memory protection table (MMPT), in accordance with various aspects of the present disclosure.

FIG. 6 is a block diagram further illustrating the leaf-encoded MPTE of FIG. 4 and a decomposition of an XLEN 64 supervisor physical address (SPA), to control access of a modified look-up of a memory protection table (MPT), in accordance with various aspects of the present disclosure.

FIG. 7 depicts an XLEN 32 MPTE format for a leaf-encoded MPTE to provide access control using a single table capable of supporting up to two or four supervisor domains (SDs), according to various aspects of the present disclosure.

FIG. 8 is block diagram illustrating a look-up process to derive access permission using the leaf-encoded MPTE of FIG. 7, according to various aspects of the present disclosure.

FIGS. 9A and 9B further illustrate the control and status register (CSR) of FIG. 8 for deriving permissions, according to various aspects of the present disclosure.

FIG. 10 is a process flow diagram illustrating a method for enhanced unified memory management table (MMT) operation, according to various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Many modern-day processors are developed based on proprietary processor architectures. Conversely, a fifth-generation (V) reduced instruction set architecture (RISC-V) is an open-source instruction set architecture (ISA) used to develop custom processors for a variety of applications. The RISC-V ISA, which was developed at the University of California, Berkeley, is considered the fifth generation of processors built on the concept of a reduced instruction set computer (RISC). Unlike proprietary processor architectures, RISC-V is an open-source ISA used for the development of custom processors targeting a variety of end-user applications.

RISC-V describes a scheme to provide access control permissions to the memory (e.g., a physical address space) associated with a processor. The memory may include multiple memory regions. Multiple supervisor domains (SDs) are associated with the multiple memory regions such that each SD is associated with one or more memory regions of the memory. Each SD may be associated with its own memory protection table (MPT). The MPT may be a multi-level hierarchical structure of tables. The MPT for each SD may include one or more access control permission bits (e.g., for attributes such as read (R) access control permission, write (W) access control permission, execute (X) access control permission) for a respective SD.

In practice, there may be a large number of the SDs associated with the memory. Because there is one MPT configured for each SD, there is also a large number of MPTs. In such cases, the maintenance of the large number of MPTs may be a complex task. In some cases, arbitrary sharing of the memory regions of the memory between the SDs may be possible. For example, one or more memory regions of the memory may be shared between or are associated with two or more SDs. In such cases, determining a current access control permission status of a particular memory region (e.g., which may be shared between the two or more SDs), is checked based on information included in the MPTs for all SDs (e.g., any SDs may be associated with the particular memory region). Due to such cases, there is also a desire to maintain a dedicated structure in the memory for specifying shared memory regions between the SDs.

In some cases, multiple fine-granular access control permissions (e.g., such as read/execute (RX) access control permission, read/write (RW) access control permission, read/write/execute (RWX) access control permission, or none) in the MPTs for the SDs may not be required (e.g., when virtual address regions of the memory may already be access-controlled by stage-1 (OS) or stage-2 (hypervisor) page tables). In such cases, a simple access/no-access control permission set in the MPTs for the SDs may be sufficient. However, in a current processor system, unnecessary space is consumed in the memory by including the fine-granular access control permissions (e.g., in the MPTs for the SDs) and in hardware control structures (e.g., a translation lookaside buffer (TLB)).

Resource-constrained applications relying only on memory access control enforced by physical memory protection (PMP) registers may face limitations. For example, the current processor system using the PMP-based range access control may face limitations, as a range number is usually kept small (e.g., 16) due to power considerations and design complexity (e.g., processor critical path). This may result in undesired compromises between security and functional requirements. In some cases, a page table-based approach may be an alternative, however, managing multiple page tables for the multiple MPTs may also be a complex task.

Aspects of the present disclosure relate to techniques for managing one or more memory protection tables (MPTs) for a memory in reduced instruction set computer (RISC) systems. In particular, some implementations configure a single MPT for different memory regions of a memory in RISC systems. For example, instead of providing multiple MPTs for multiple SDs corresponding to the multiple memory regions of the memory, a single (unified) MPT is configured for at least a certain number of SDs.

The use of the single MPT for the multiple SDs may consume less memory space and also enable easier access control permission management for the multiple SDs. For example, the single MPT may include access control permissions for all of the SDs, so only a single MPT has to be checked to determine the access control permissions for all of the SDs. Also, the use of the single MPT may make it easier to update the access control permissions for the SDs.

The memory demand specified to store the single MPT may be reduced. For example, the techniques described may not specify any fine-granular access control permissions for the SDs (e.g., access allowed for the SDs, access denied for the SDs) in the MPT, because the access control permissions for the SDs may be sufficiently managed on a virtual address level (e.g., stage-1, stage-2 translation in a memory management unit (MMU)). Accordingly, bits reserved for a page table entry (PTE) in the MPT for the fine-granular access control permissions may be repurposed to govern access on the SDs instead. This may also reduce the total MPT memory footprint by up to 66%.

In various aspects of the present disclosure, the techniques described may support the use of a multi-bit fine-granular access control permission set, which may be shared by all of the SDs (e.g., when there is memory region sharing between the SDs). This may enable total MPT memory footprint reduction by 50%.

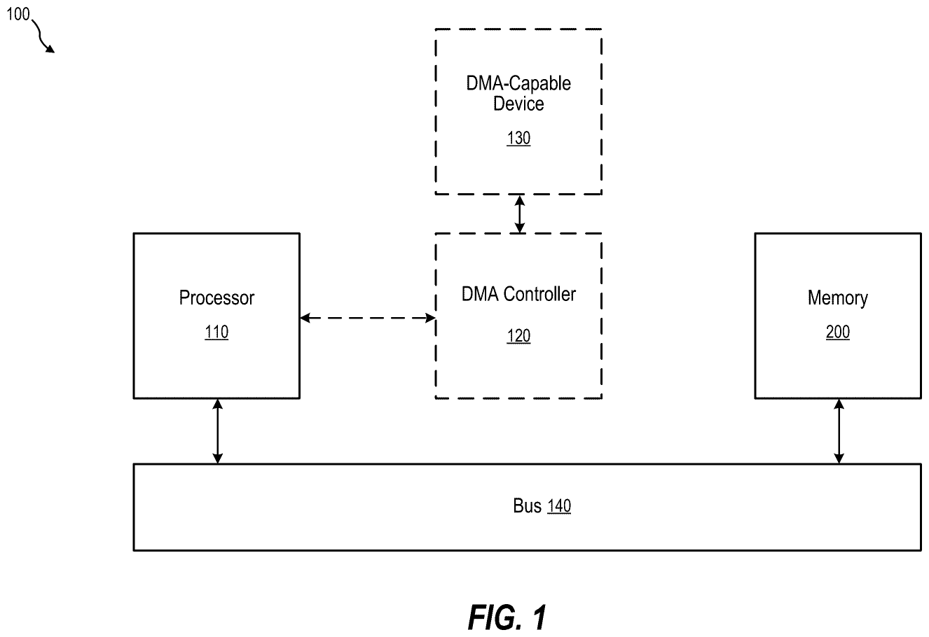

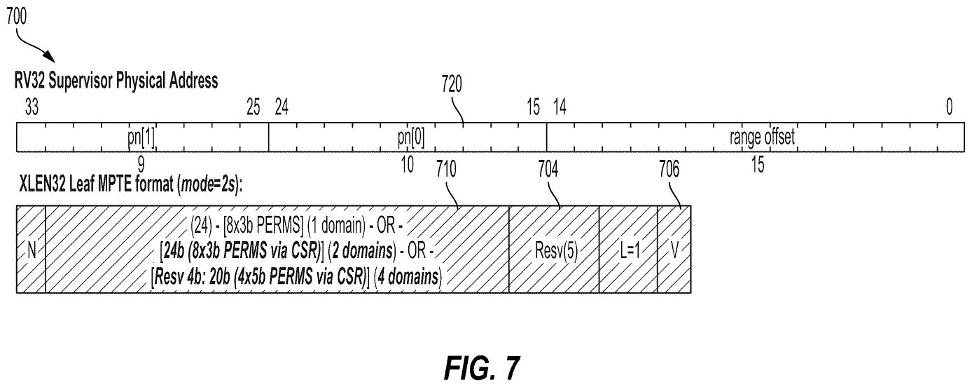

The described techniques may reduce TLB pressure because memory region/page permissions for the different SDs may be managed in a single entry within the MPT. Furthermore, the use of the limited number of the SDs may simplify all hardware design aspects dependent on a number of the SDs (e.g., the TLB, cache tags, and fence operations). The proposed techniques for configuring MPTs for the multiple SDs may be further understood with reference to FIGS. 1-6. Additionally, microcontroller implementation in which a memory management unit (MMU) is unavailable is illustrated in FIGS. 7-10.

FIG. 1 is a block diagram illustrating a reduced instruction set computer (RISC) system 100 including at least one processor 110 and at least one memory 200 utilizing an enhanced, unified memory protection table, in accordance with certain aspects of the present disclosure. As shown in FIG. 1, a RISC system 100 includes a processor 110 (e.g., a central processing unit (CPU)) and a memory 200 coupled via a bus 140. The memory 200 may include all of a physical address space including at least a static random-access memory (SRAM), a dynamic random-access memory (DRAM), and a memory mapped input/output (MMIO) space.

The memory 200 may store user application programs and data associated with the user application programs. The processor 110 may execute tasks such as the user application programs. Additionally, the processor may include processing cores and an MMU. The processing cores are engines in the processor for executing the tasks. In various aspects of the present disclosure, the tasks executed on the processing cores may not access the memory directly using physical addresses of the memory. Instead, the tasks may access a virtual memory through virtual addresses. The MMU, coupled between the processing cores and the memory, may map the virtual addresses of the virtual memory to the physical addresses of the memory.

In various aspects of the present disclosure, the RISC system 100 include a direct memory access (DMA) capable device 130 and a DMA controller 120. As described, DMA is a feature that allows certain hardware subsystems to access the memory independently of the processor. For example, DMA is a feature that transfers data between the memory and peripheral devices (e.g., hard drives) without intervention from the processor.

The DMA-capable device 130 may be a peripheral device that allows direct transfer of data to/from the memory without processor intervention. The DMA-capable device 130 may include disk drives, graphics cards, network cards, and sound cards, which may share and receive data from the memory. For example, data transfers between the memory and the DMA-capable device 130 may occur through DMA channels.

The DMA controller 120 may be used to start the memory read/write cycles and to generate memory addresses. The processor 110 instructs the DMA controller 120 to begin the data transfer between the memory 200 and the DMA-capable device 130 and associates a memory address to use. The DMA controller 120 may set destination addresses and read/write lines to the memory. The DMA controller 120 may change an internal memory address with each transferred byte of data until a full block of data is transferred.

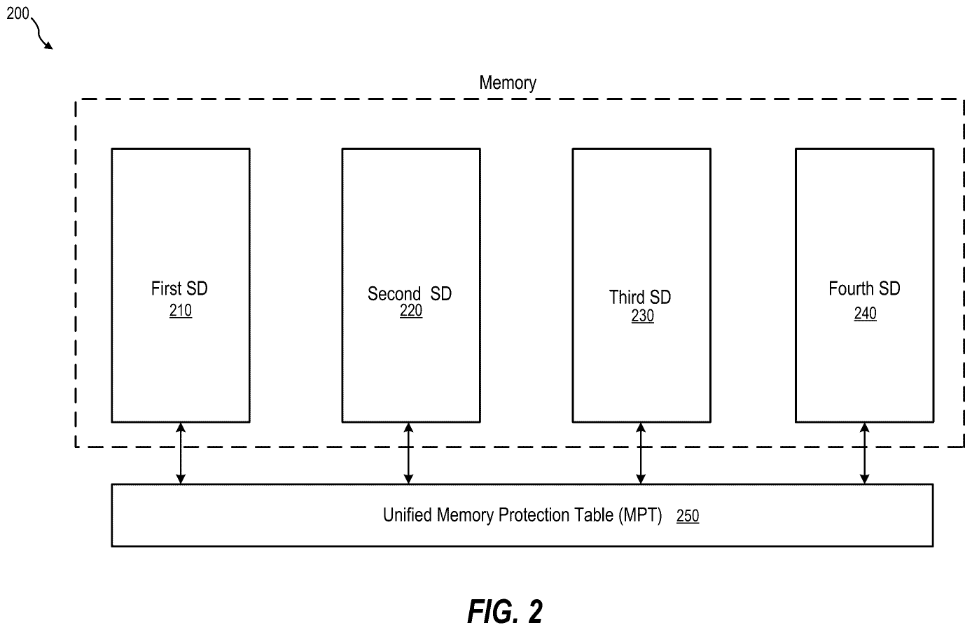

The DMA controller 120 may move data to and from the memory using various methods. For example, when the processor 110 gives the DMA controller 120 access to the bus 140, the DMA controller 120 may transfer an entire data block in one contiguous sequence. Once completed, control of the bus 140 reverts back to the processor 110. This method renders the processor 110 inactive while transferring the data. The DMA controller 120 may initially gain access to the bus 140 using bus request and bus grant processes. In some aspects, the DMA controller 120 may transfer the data only when the processor 110 is executing operations that do not use system buses (e.g., the bus 140). With this DMA transfer method, the processor does not have to stop performing its operations. The memory 200 is further illustrated in FIG. 2.

FIG. 2 depicts example multiple supervisor domains (SDs) associated with different memory regions of at least one memory 200 and including an enhanced, unified memory protection table (MPT) 250, in accordance with various aspects of the present disclosure. FIG. 2 depicts a diagram showing multiple SDs (e.g., four SDs) associated with different memory regions of the memory 200 (e.g., a physical memory such as the memory 200 of FIG. 1). An enhanced unified MPT 250 may be configured for the multiple SDs.

A processor architecture may define an execution mode for supervisor software, which is referred to as S-mode. The S-mode software may enable a hypervisor extension to host one or more virtual machines. There may be a single SD of execution with access to all of the memory per virtual machine or per hypervisor instance. The hypervisor may be software that manages the virtual machines. The virtual machine may be an efficient, isolated duplicate of a real computer system.

Various aspects of the present disclosure define SD access protection to support physical address space (e.g., memory and devices such the DMA-capable device 130 of FIG. 1) isolation for more than one SD. The SDs may enable trusted execution use cases for RISC-V systems. Additionally, the SDs may be used to reduce a supervisor trusted computing base (TCB), with differential access to the memory and other platform resources (e.g., in confidential computing, security services, and secure devices).

Host software elements, including an operating system and virtual machines, may operate in a hosting SD (e.g., a first SD 210) based on an SD identification (SDID). The hosting SD may interact with multiple distrusting SDs (e.g., a second SD 220, a third SD 230, and a fourth SD 240) via the support of a root domain security manager (RDSM) application. Each SD may host its own software and applications.

As described, the TCB may be composed of hardware, software, and firmware elements that are trusted by a relying party to protect confidentiality and integrity of relying parties workload data and execution against a defined adversary model. The TCB boundary, particularly software TCB, is defined as the boundary between the trusted elements, those able to enforce security policies and ensure correct execution, and the untrusted components that, even if malicious, cannot override or abuse the security policies.

Application workloads on multiple RISC platforms may rely on hardware-based isolation primitives that are managed by host and privileged software. Host software (e.g., operating systems and virtual machine monitors) may have unfettered access to the memory, devices, and hardware isolation mechanisms (e.g., an MMU or physical memory protection (PMP) registers). In practice, RISC platforms may have a very large TCB and many threat actors that influence the TCB. Utilizing SD isolation reduces this TCB to the RDSM and machine mode software, and any privileged software within the SD itself. For example, in a data center environment, the host software, devices and device drivers, cloud operators, orchestration services, and other workloads are all considered threat vectors. Additional threats originate due to deployment models, for example, an embedded platform deployed in a field is exposed to physical threat vectors.

In these scenarios, isolated SDs are utilized to express differentiated trust models and secure access to platform resources. For example, each SD may use resources (e.g., such as memory input/output regions, processing elements, devices, and interrupts) to perform their function. For example, the application workloads are software elements owned and deployed by a single organization that is hosted by a platform operator (e.g., cloud provider on a platform that can host more than one organization workload simultaneously). The application workloads may operate in a context of the SDs.

Additionally, each SD may be associated with a set of physical address regions of the memory that are isolated from other SDs on a same RISC platform, in which the root domain security manager (RDSM) application has sole access to all of a physical address space (e.g., of the memory). Each SD may be associated with a supervisor domain identification (SDID) that is used to facilitate physical address protection fences on a per-SD basis. For example, the SDs may rely on the TCB, which consists of the RDSM application and a hardware (e.g., a device, a system on a chip (SoC), a root-of-trust (RoT)) that enforces isolation properties for the SD.

An RDSM application may utilize the PMP registers and/or extensions specified by an Smmtt (“Smmtt extensions”), an RISC-V task group specifying SD related ISA and non-ISA extensions (e.g., an MPT to isolate the memory between the SDs). Isolation of the application workloads in the SD may be a responsibility of a hypervisor managing the SD, referred to as a SD security manager (SDSM) application. Additionally, the RoT is an isolated hardware/software subsystem with immutable firmware, and isolated compute and memory elements that form the TCB of a trusted execution environment (TEE) system. The RoT may manage cryptographic keys and other security critical functions such as system lifecycle and debug authorization. For example, the RoT provides trusted services to other software, in which the RoT is the TCB, such as verified boot, key management, security lifecycle management, sealed storage, device management, crypto services, and/or attestation. The RoT may be an integrated or discrete element and may be used to manage device identities for attestation. The TEE may be a set of hardware and software mechanisms that may allow creating attestable and isolated execution environment.

As described, the Smmtt extensions may be an extension to set access control permissions for a memory region (or a page) associated with the SD. The Smmtt extension may allow for dynamic changes of the access control permissions for the memory region associated with the SD. The access control permissions may be programmed via an MPT structure. The MPT may be a flat structure or composed of multiple levels. A physical page number (PPN) of a root table of the MPT may be programmed. When the Smmtt extension is implemented, the MPT and the PMP registers may remain active. Although there is no option to disable the MPT, the MPT may be disabled if granular memory access control is not specified by configuring a bare MPT mode.

Various aspects of the present disclosure enable attestation of each SD independently from other SDs. For example, sensitive data may be entrusted to a particular SD after verifying trust properties statically (e.g., via a boot operation) or dynamically (e.g., via the attestation). The trust properties may be established as part of hardware and software supply chains, and system configurations and may be additionally evaluated using attestation mechanisms. Additionally, the attestation may be a process in which a relying party may assess trustworthiness of a confidential computing environment based on verifying a set of evidence that is cryptographically endorsed by a hardware ROT.

The use cases for SD isolation may range from embedded to application/server-class platforms. Some examples in which multiple SDs are used include: (1) a trusted execution environment domain that isolates security services/applications; (2) a confidential computing domain that enforces confidentiality and integrity for workload data-in-use from a host/untrusted hypervisor along with attestation of the TCB, a host (operator) domain that manages resources on a platform and may assign resources to other domains; and (3) a service-provider domain with exclusive access to some DMA-capable devices.

The SD access protection extensions may be used by an M-mode RDSM application to program access policies for SD operation. The Smmtt extension may enable the RDSM application to program permissions for physically-addressed memory (or device-mapped regions) by a device operating within the SD. Associating the device with the SD implies that any physical-addressable region access occurring in a context of the SD may be subject to access-checks for that SD. Hence, software/hardware accesses that originates from the SDs, other than the allowed SD, may be explicitly prevented/allowed. The RDSM application may have access to the physical memory for all of the SDs. During security usage, read or write accesses to MPT structures may be restricted and managed by the RDSM application.

The memory regions may be accessed by the devices (e.g., processors/IO devices) on a platform. When a device is assigned to the SD, the device may perform memory accesses in a context of the SD. For memory accesses that use a physical address, an SDID (or IOSDID for IO devices) is utilized as the SD identifier programmed into a control and status register (CSR). The CSR may be programmed on the device by the RDSM application. The assignment of the device to the SD may be static (e.g., the device assignment to a virtual machine) or dynamic (e.g., scheduling the virtual machine virtual CPU within the SD). The MPT for the SD active on the device may be programmed on the device along with the SDID.

In practice, an MPT does not perform any address translation. The MPT may provide the access control permissions for a physically addressed region/page associated with each SD to enforce isolation properties per use case requirements. For example, an MPT checker is a functional block that looks up the MPT using a physical address as an index to retrieve the access control permissions for the different SDs. During operation, the MPT checker ensures that a load initiated by the device is directed to a physical address that is readable, and for a store initiated by the device, the physical address is also writable; otherwise, the MPT checker reports a fault.

An MPT access violation may be reported as a trap to the M-mode RDSM application. The MPT checker may be implemented as an MMU extension in the device, and/or in an input/output interconnect to check device accesses. The MPT checker may be designed to work together with page-based virtual memory systems and physical memory protection (PMP) mechanisms. Read, write, and execution permissions for the memory may be derived from a page table, the PMP, and/or the MPT. An access to the memory is restricted unless each of the protection mechanisms allows the access.

The MPT may be used to provide permissions for physical memory addresses that hold a regular main memory or an input/output memory. The memory may be assigned to the RDSM application to bootstrap subsequent run-time look-up structures for the MPT. The memory may be covered by the MPT, though some memory may not be eligible to be qualified for assignment to a specific SD.

The MPT may support both static and run-time configurability. A memory region (e.g., consisting of one or more pages) of the memory may be (re)assigned from one SD to another SD at a run-time (e.g., by revoking the permission for one SD and assigning permissions to another SD). A run-time configuration may be performed via M-mode CSRs and/or in-memory structures. The in-memory structures used for the MPT may themselves be access-limited to the RDSM application by use of the MPT structures to disallow any SD from accessing the structures unless explicitly delegated by the RDSM application to a particular SD (e.g., per use case policies).

To support MPT dynamic reconfiguration, an interface is configured to provide a set of attributes by passing requests to a trusted driver (e.g., in the RDSM application) that may reconfigure the memory region assignment. Additionally, converting the memory regions assignment from one SD to another SD may involve platform-specific operations based on an enforcement mechanism, such as TLB/cache flushes, that may be enforced by the RDSM application and the hardware. The RDSM application may change settings and flush caches if specified, so incoherency of the system is limited to the transitions between SD assignment settings.

During operation, a device (e.g., a processor) may perform accesses to the memory exclusively accessible to its SD, or to the memory shared globally with the one or more SDs. This memory sharing between the SDs is achieved by making a physical memory region accessible to the SDs via the MPT structure associated with the device. The access to physical addresses initiated from the device assigned the SDID may be denied by virtue of the access control permissions in the MPT look-up, in which these disallowed accesses from the device cause the RDSM application to report a fault. When the device access is disallowed by the MPT, an input/output subsystem may log an error for the RDSM application, which may delegate the error to the SD.

An intra-domain isolation of the memory between two devices (e.g., processors) belonging to a same SD, but different workloads, may be achieved via a use of the MMU and/or the PMP registers, depending on a type of platform and a type of access. To successfully achieve this isolation of the memory, page table structures for SD workloads may be managed by the SDSM application and paging structures may be located in a portion or region of the memory exclusively accessible only to the SD.

In various aspects of the present disclosure, the SDs may be granted control over DMA-capable devices. When such direct device association is supported, a system also incorporates multiple instances of an input-output memory management unit (IOMMU). Each IOMMU instance may be tied directly to the SD, allowing the SD to manage address translation and protection for the DMA that originates from devices under its control. To uphold isolation properties, the DMA from the devices and the IOMMU linked with the SD may adhere strictly to access protections encoded in the MPT. Additionally, using the MPT, the RDSM application may enforce the IOMMU memory-mapped programming regions to be access-restricted to the SD to which the IOMMU is assigned.

At any given time, a solitary SD may be scheduled for execution by the RDSM application. As part of this scheduling, the RDSM application programs a pointer to the MPT into a CSR within the device. The DMA-capable devices connected to the SD remain continuously active. The DMA-capable devices may initiate the DMA even if the associated SD is not currently active. As a result, the MPT of all the SDs may be constantly active for DMA protection.

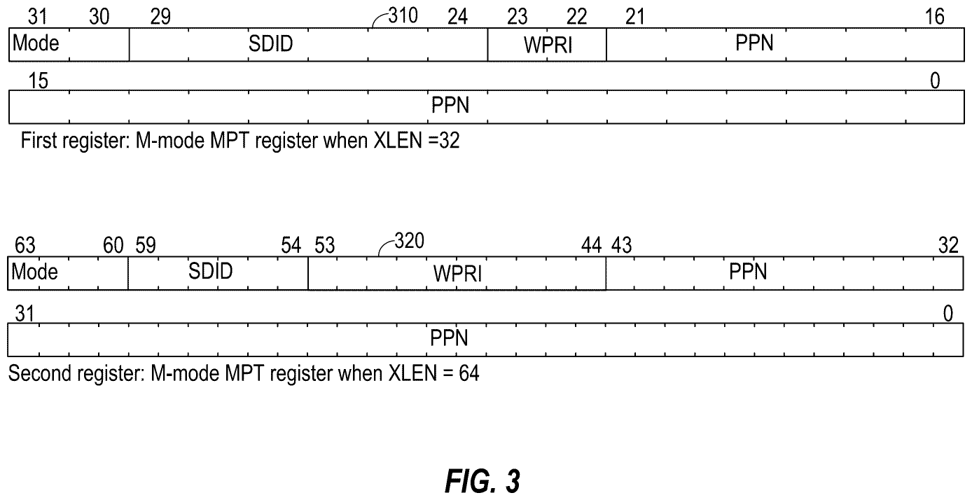

FIG. 3 depicts example first and second M-mode MPT registers 310, 320 to enable an enhanced, unified memory protection table (MPT), in accordance with various aspects of the present disclosure. As shown in FIG. 3, M-mode MPT registers 310, 320 provide an interface to program an active SD under which a device or a processor is operating. For example, an SDID programmed via this interface provides a local identifier for the device that is used to tag device local resources to access-control data associated with the SD.

The M-mode MPT registers 310, 320 may be XLEN-bit read/write registers. The term XLEN refers to a width of X register in bits. XLEN for the first M-mode MPT register 310 is equal to 32 and the second M-mode MPT register 320 is equal to 64. The M-mode MPT registers 310, 320 may be used to control physical address protection for multiple SDs. Each M-mode MPT register 310, 320 may hold a physical page number (PPN) of a root page of an MPT. Additionally, each register holds an SDID that may facilitate address protection fences on a per-SD basis, a mode field that may select an address protection scheme (e.g., MPT mode to be enforced) for physical addresses of the memory, and a reserved writes preserve, reads ignore (WPRI) values field. The M-mode MPT registers 310, 320 may be considered active for purposes of a physical address protection algorithm unless an effective privilege mode is M.

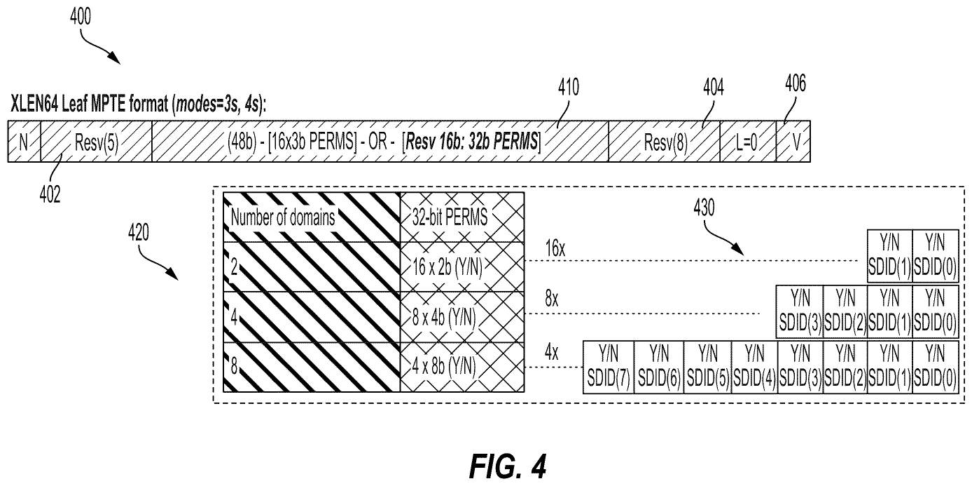

FIG. 4 is a block diagram illustrating a leaf-encoded memory protection table extension (MPTE) 400 according to an M-mode enhanced, unified MPTE format, in accordance with various aspects of the present disclosure. As shown in FIG. 4, the leaf-encoded MPTE 400 includes an access control permissions (PERMS) field 410 for access control permission bits for multiple SDs in a unified memory protection table (MPT) for the multiple SDs, in accordance with various aspects of the present disclosure.

FIG. 4 depicts an XLEN 64 MPTE format for the leaf-encoded MPTE 400 to provide access control using a single table capable of supporting two, four, or eight supervisor domains (SDs), according to various aspects of the present disclosure. In this example, the leaf-encoded MPTE 400 includes the PERMS field 410 for access control permission bits for multiple SDs, a first reserved bit field 402 (“Resv(5)”), a second reserved bit field 404 (“Resv(8)”), and a valid bit (V) field 406 of the leaf-encoded MPTE 400. In this example, the leaf-encoded MPTE 400 provides a structure to access control permissions for one or more physical addresses of memory regions (e.g., for different SDs) of a memory, and is looked up per a programmed mode. For example, the leaf-encoded MPTE 400 for the multiple SDs includes access control permission bits for each of the multiple SDs.

The various fields of the leaf-encoded MPTE 400 enable simplified MPT software management in an RDSM. In this example, page sharing information is obtained from a unified memory protection table (MPT) 420, instead of searching through n instances. Additionally, up to eight domains enable support for legacy use cases in high-end embedded applications with room for extensions. In this example, 1-bit permission granularity (full access/no access) is sufficient for MMU-based deployments (e.g., full access ≡RWX). Permission is obtained according to a bit position of a 2/4/8-bit field to access a leaf-encoded MPTE bitmap 430. For example, mmpt. SDID is a mask for an active SD. In the two-domain mode, the 1-bit permission granularity is determined according to the ID of the supervisor domain (e.g., SDID(1), SDID(0)) based on a defined mapping. The leaf-encoded MPTE bitmap 430 is similarly configured for four-domain and eight-domain modes to provide one-bit permission granularity.

In one aspect, an access control permission bit may indicate read access control permission is allowed for an address space for a particular SD of the multiple SDs. In another aspect, an access control permission bit may indicate execute access control permission is allowed for an address space for a particular SD of the multiple SDs. In another aspect, an access control permission bit may indicate read and execute (but no write) access control permission is allowed for an address space for a particular SD of the multiple SDs. In another aspect, an access control permission bit may indicate read and write (but no execute) access control permission is allowed for an address space for a particular SD of the multiple SDs. In another aspect, an access control permission bit may indicate read, write, and execute (RWX) access control permission is allowed for an address space for a particular SD of the multiple SDs. In another aspect, an access control permission bit may indicate no read, write, and execute access control permission is allowed for an address space for a particular SD of the multiple SDs.

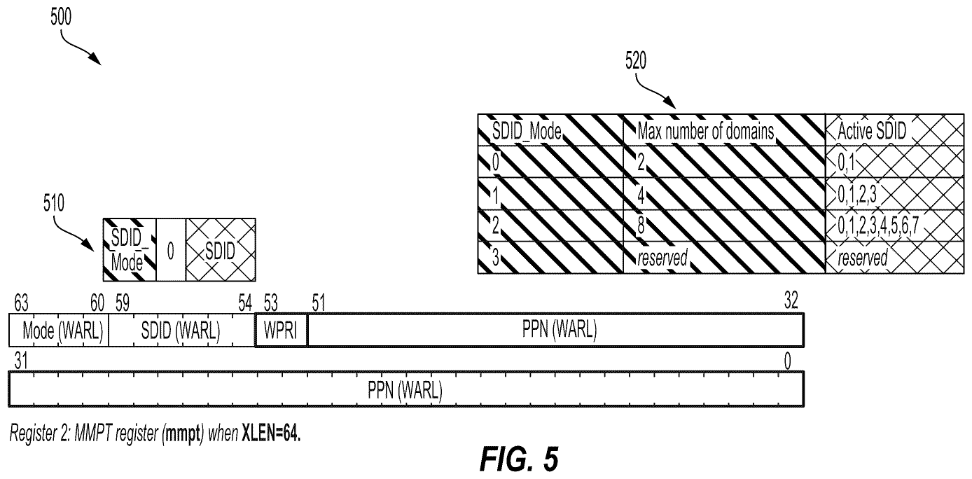

FIG. 5 is a block diagram further illustrating the second M-mode MPT register of FIG. 3, to control access of an enhanced, unified memory protection table (MPT), in accordance with various aspects of the present disclosure. As shown in FIG. 5, a second M-mode MPT register 500 is configured to support two additional modes (e.g., 3 s, 4 s) for three-stage level look-up and four-stage level look-up. In this example, a modified SDID encoding field 510 is utilized for the 3 s or 4 s modes, in which a two-bit mode field specifies a mode of the single table operation of a unified MPT 520. The unified MPT 520 is accessed according to the SDID_Mode field of the modified SDID encoding field 510 to determine the maximum number of domains and the associated active SDID associated with the respective domain to determine access control.

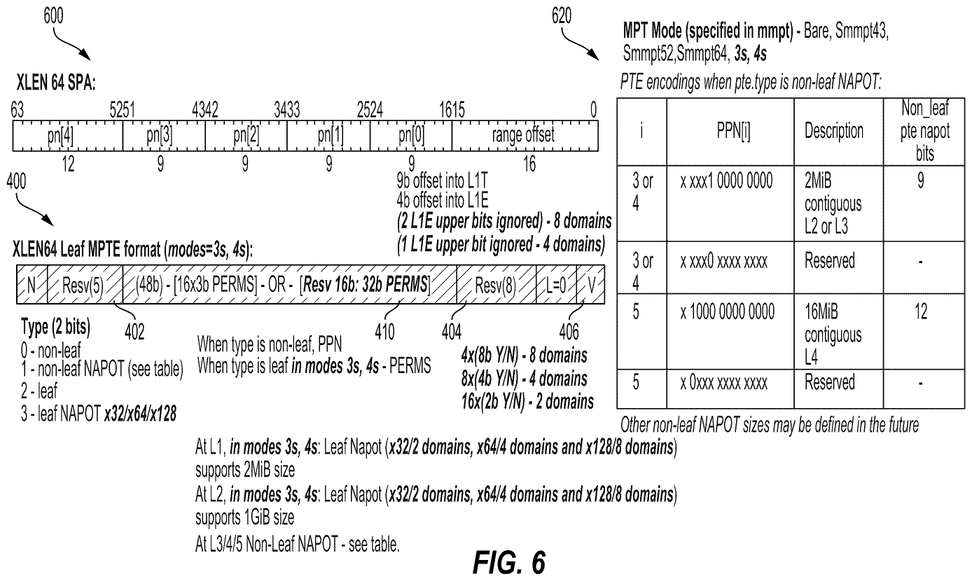

FIG. 6 is a block diagram further illustrating the leaf-encoded MPTE 400 of FIG. 4 and an XLEN 64 supervisor physical address (SPA), to control access of a modified look-up of a unified memory protection table (MPT), in accordance with various aspects of the present disclosure. As shown in FIG. 6, an XLEN 64 SPA 600 is configured as a physical page number (PPN) rooted structure (e.g., pn[4], pn[3],pn[2], pn[1], pn[0], range offset) for modified, single table MPT access. Additionally, the type (T) field (two bits (2 b) of the leaf-encoded MPTE 400 is further illustrated in FIG. 6. In this example, the various types include 0—non-leaf; 1—non-leaf naturally aligned power-of-two (NAPOT) (see table 620); 2—leaf; and 3—leaf NAPOT x32/x64/x128.

As further illustrated in FIG. 6, when the T-field is non-leaf, a physical page number (PPN) is utilized to determine access control. When the T-field is leaf in modes 3 s, 4 s, the 32-bit permissions (PERMS) field 410 (32 b PERMS) of the second M-mode MPT register 500 is utilized to determine access control. At level one (L1), in modes 3 s, 4 s: Leaf NAPOT (x32/2 domains, x64/4 domains, and x128/8 domains) supports 2 mebibyte (MiB) size. At level two (L2) in modes 3s, 4s: Leaf NAPOT (x32/2 domains, x64/4 domains, and x128/8 domains) supports 1 gibibyte (GiB) size. Otherwise at level three (L3)/level four (L4)/level five (L5) non-leaf NAPOT (see the table 620). In this example, the table 620 supports page table entry (PTE) encoding to enable physical page number look-up (PPN[i]), a description, and non-leaf PTE NAPOT bits.

In examples shown in FIGS. 4-6, a unified memory protection table may contain access permissions for multiple domains to a given memory page or region. For example, as shown in FIG. 4, during physical memory access, a table walk finds the leaf-encoded MPTE bitmap 430 containing the permission for the address being accessed. In this example, permissions for each of the 2, 4, or 8 domains are encoded into a single table. While utilizing a single table having a small table size is efficient, the leaf-encoded MPTE bitmap 430 is limited to binary control (e.g., allow/disallow per domain). As a result, in the examples shown in FIGS. 4-6, an MMU may be utilized to enforce the read/write/execute (RWX) control permissions on the physical memory address space for the active set of supervisor domains.

In 32-bit embedded micro-controller systems, in which memory size is of significance, there is a desire for a small, unified table for supporting reduced software complexity, while providing read/write/execute (RWX) control permission per domain. Unfortunately, this unified table cannot easily be accomplished with a single table format, as three times as much information would triple the size of the tables in such micro-controller implementations that do not include a memory management unit (MMU).

FIG. 7 depicts an XLEN 32 MPTE format for a leaf-encoded MPTE 700 to provide access control using a single table capable of supporting up to two or four supervisor domains (SDs), according to various aspects of the present disclosure. As shown in FIG. 7, an RV32 supervisor physical address 720 is configured as a physical page number (PPN) rooted structure (e.g., pn[1], pn[0], range offset) for modified, single table MPT access. In this example, the leaf-encoded MPTE 700 includes access control permission (PERMS) field 710 for access control permission bits for multiple SDs, a reserved bit field 704 (“Resv(5)” field), and a valid (V) bit field 706. The leaf-encoded MPTE 700 provides a structure including access control permissions for one or more physical addresses of memory regions (e.g., for different SDs) of a memory, and is looked up per a programmed mode. For example, the leaf-encoded MPTE 700 for the multiple SDs may include permission obtained from a permissions (PERMS) field 710 of the leaf-encoded MPTE 700.

As shown in FIG. 7, the PERMS field 710 carries 24 bits. Various aspects of the present disclosure repurpose the PERMS field 710, while leaving other bit fields unchanged. Instead of carrying 8×3 permission bits, in the 4-domain case, the PERMS field 710 shall carry four 5-bit bitmaps and keep the remaining 4 bits of the 24-bit field reserved. In the 2-domain case, the 24-bit PERMS field is fully utilized and carries eight 3-bit bit bitmaps.

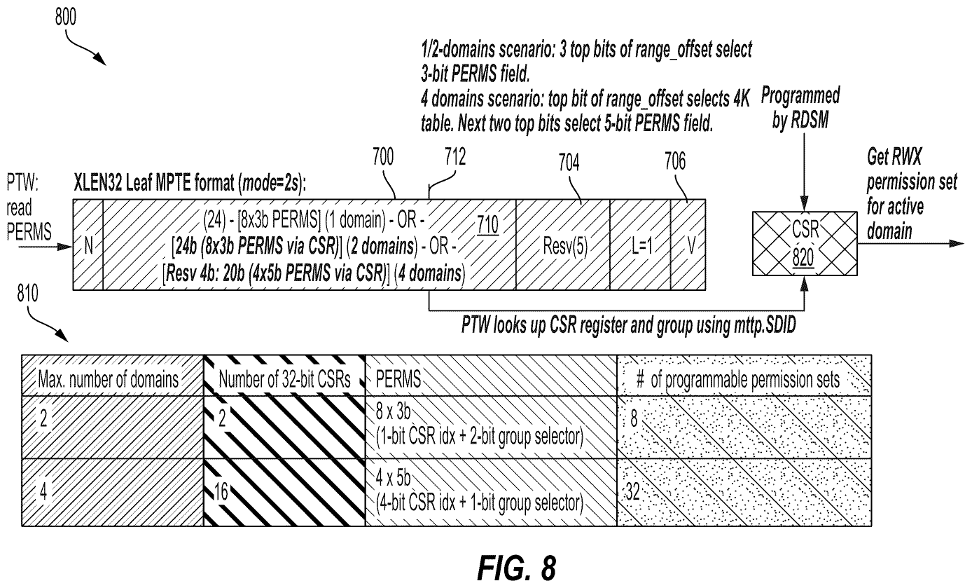

In single-domain (default case), the top 3 bits of range_offset of the RV32 supervisor physical address 720 are used to identify one of eight 3-bit PERMS fields. Each PERMS field holds an XWR encoding for the active domain. In 2 domain case, the top 3 bits of the range_offset are used to identify one of eight 3-bit PERMS fields. Each PERMS field identifies a CSR (first bit) and an 8-bit group field in the CSR (other 2 bits). Each 8-bit group field holds XWR for 2 domains. In 4 domain case, the top bit of the range_offset is used to identify one of two 4K MPT tables. The following two bits of range_offset are used to identify one of four 5-bit PERMS fields. The first 4 bits of each PERMS field identify one of 16 CSRs. The fifth bit identifies one of the two 16-bit group fields in the CSR. Each 16-bit group field holds XWR for four domains, as further illustrated in FIG. 8.

FIG. 8 is block diagram illustrating a page table walk (PTW) process 800 to derive access permission using the leaf-encoded MPTE 700 of FIG. 7, according to various aspects of the present disclosure. As shown in FIG. 8, the leaf-encoded MPTE 700 enables simplified MPT software management in RDSM. In this configuration, page sharing information can be obtained from a single table, instead of searching through n instances. Additionally, the availability of up to four domains enables support for legacy use cases in embedded applications with room for extensions. A unified MPT 810 includes a maximum number of domains column, a number of 32-bit configuration status registers (CSRs) column, a PERMS column (e.g., 20-bit/24-bit) and a number of programmable permission set column.

As shown in FIG. 8, the page table walk (PTW) process 800 reads the PERMS field of the leaf-encoded MPTE 700 to determine access control permission. In this example, the access control permission is obtained from an identification (ID) value field (e.g., ID field 712) in the PERMS field 710 of the leaf-encoded MPTE 700. Granularity is expressed through level of indirection (e.g., additional CSRs). In this example, one additional mode (2 s) is suggested to support two-stage level look-up. The leaf-encoded MPTE 700 utilizes the same SDID_mode encoding as used for XLEN 64.

In this example, each of read/write/execute (R/W/X) permissions for the four domains shown in the unified MPT 810 results in expression of 2⁵ different sets of permissions, from a total possible of 2¹². This number of different sets of permissions is sufficient for practical applications as many of the possible combinations are redundant (e.g., write-only permission from a single domain with no access from all other domains). Additionally, this number of different sets of permissions maintains the leaf-node of the page tables at a manageable size, in which 5 bits per memory region (e.g., ID field 712) are specified to encode the domain permissions. This configuration provides the benefits of faster and more efficient, simplified software management advantages of a single set of tables, direct visibility to software of memory sharing and access writes without searching multiple tables, all while expressing the fine-grained permission control required in embedded systems. An advantage over prior art systems is that the benefits can be achieved without large increases in table sizes.

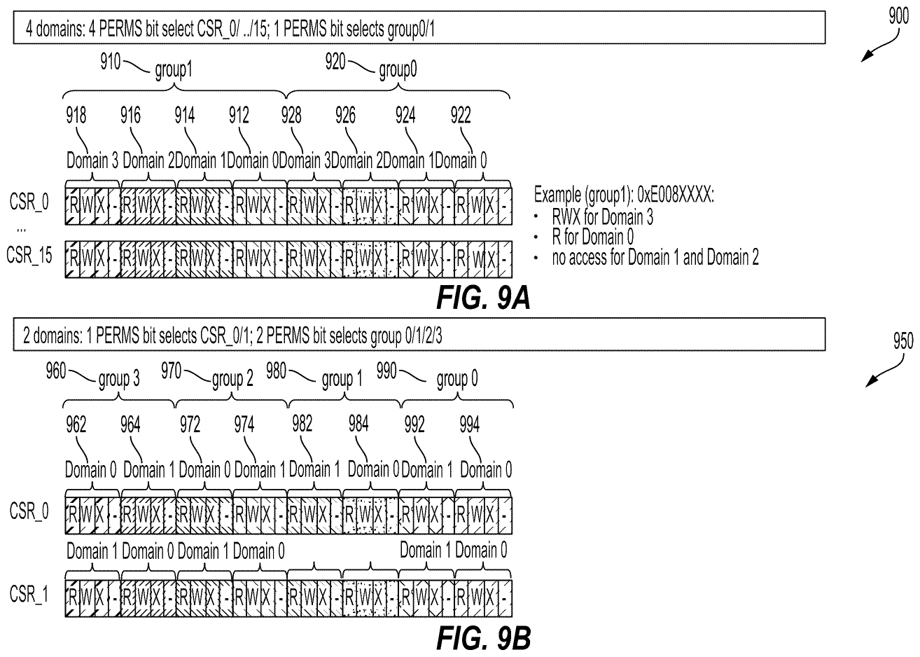

As shown in FIG. 8, the leaf-encoded MPTE 700 contains an identifier for the memory region being accessed. This identifier would be used to look up the combination of permissions allowed, per domain, from a set of programmable registers. In this example, a page table walk (PTW) reads the PERMS field 710 to identify and select the ID field 712 of the leaf-encoded MPTE 700. The look-up process identifies the 5-bit PERMS field for all (active) domains (of the domain configuration) and decodes the permissions for these domains according to the CSR settings. In this implementation, a CSR 820, which is programmed by the RDSM, is accessed according to the SDID to determine the read/write/execute (RWX) permission for the SD, for example, as shown in FIGS. 9A and 9B.

FIGS. 9A and 9B further illustrate the CSR 820 of FIG. 8 for deriving permissions based on various domains, according to various aspects of the present disclosure.

FIG. 9A further illustrates the CSR 820 of FIG. 8 according to a four-domain configuration 900 (e.g., 4×5 b PERMS). In this example, the CSR 820 is shown as sixteen CSRs (e.g., CSR_0, . . . , CSR_15). According to various aspects of the present disclosure, a first portion (e.g., four-bit CSR index) of the ID field 712 selected from the PERMS field 710 of the leaf-encoded MPTE 700 selects the corresponding CSR (e.g., CSR_0, . . . , CSR_15). Additionally, a second portion (e.g., one-bit group selector) of the ID field 712 selects the corresponding group field (e.g., group 0 920 or group 1 910) of the CSR. Once the group is selected, the corresponding domain field (e.g., domain 0 912, domain 1 914, domain 2 916, domain 3 918 of group 1 910 or domain 0 922, domain 1 924, domain 2 926, domain 3 928 of group 0 920) is determined according to the SDID. For example, (group 1 910): 0xE008XXXX, provides RWX for domain 3 918 and read (R) permission from domain 0 912.

FIG. 9B further illustrates the CSR 820 of FIG. 8 according to a two-domain configuration 950 (e.g., 8×3 b PERMS). In this example, the CSR 820 is shown as two CSRs (e.g., CSR_0, CSR_1). According to various aspects of the present disclosure, 1-bit index of the selected three-bit field of the ID field 712 from the leaf-encoded MPTE 700 selects the corresponding CSR (e.g., CSR_0/CSR_1). Additionally, a two-bit group selector of the three-bit field of the ID field 712 selects the corresponding group field (e.g., group 3 960, group 2 970, group 1 980, or group 0 990) of the CSR. Once the group is selected, the corresponding domain field (e.g., domain 1 962, 972, 982, 992, or domain 0 964, 974, 984, 994) is determined according to the SDID.

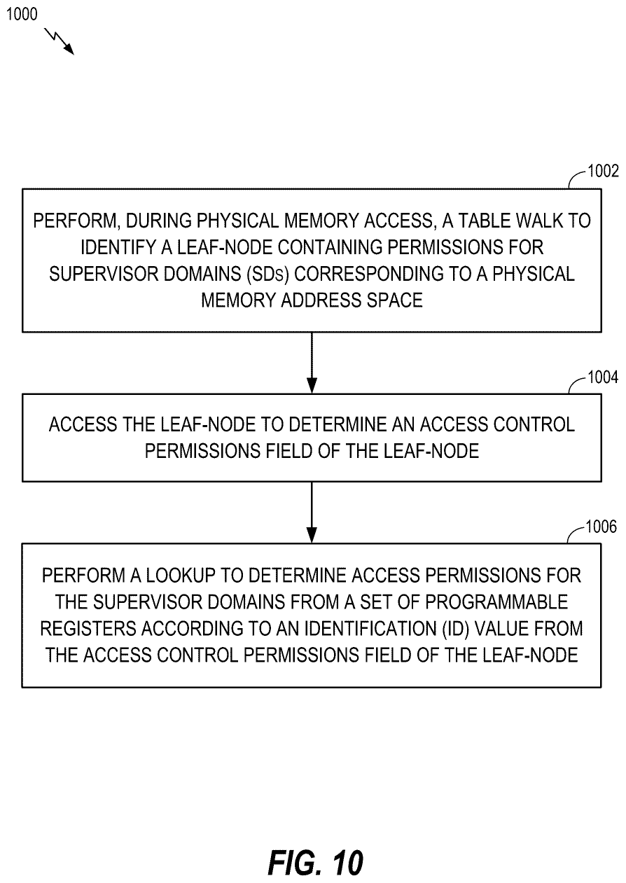

FIG. 10 is a process flow diagram illustrating a method for enhanced unified memory protection table operation, according to various aspects of the present disclosure. A method 1000 begins at block 1002, in which a table walk is performed to identify a leaf-node containing permissions for supervisor domains (SDs) during physical memory access corresponding to a physical memory address space.

At block 1004, the leaf-node is accessed to determine an access control permissions field of the leaf-node. For example, as shown in FIG. 7, the leaf-encoded MPTE 700 includes access control permission field (e.g., PERMS field 710) for access control permission bits for multiple SDs. The leaf-encoded MPTE 700 provides a structure including access control permissions for one or more physical addresses of memory regions (e.g., for different SDs) of a memory, and is looked up per a programmed mode. For example, the leaf-encoded MPTE 700 for the multiple SDs may include permission obtained from the ID field 712 of the PERMS field 710 of the leaf-encoded MPTE 700.

At block 1006, a look-up is performed to determine access permissions for the supervisor domains from a set of programmable registers according to an identification (ID) value from the access control permissions field of the leaf-node. For example, as shown in FIG. 8, the leaf-encoded MPTE 700 contain an identifier for the memory region being accessed. This identifier would be used to look-up the combination of permissions allowed, per domain, from a set of programmable registers. In this example, a page table walk (PTW) reads the PERMS field 710 to identify and select the ID field 712 of the leaf-encoded MPTE 700. The look-up process identifies the 5-bit PERMS field for all (active) domains (of the domain configuration) and decodes the permissions for these domains according to the CSR settings. In this implementation, a CSR 820, which is programmed by the RDSM, is accessed according to the SDID to determine the read/write/execute (RWX) permission for the SD, for example, as shown in FIGS. 9A and 9B.

Implementation examples are described in the following numbered clauses:
1. A method for enhanced unified memory protection table operation, the method comprising:
   performing, during physical memory access, a table walk to identify a leaf-node containing permissions for supervisor domains (SDs) corresponding to a physical memory address space;
   accessing the leaf-node to determine an access control permissions field of the leaf-node; and
   performing a look-up to determine access permissions for the supervisor domains from a set of programmable registers according to an identification (ID) value from the access control permissions field of the leaf-node.
2. The method of clause 1, in which the leaf-node is enabled according to a memory protection table entry (MPTE) format.
3. The method of any of clauses 1 or 2, in which the set of programmable registers are organized according to various group fields, and various domain fields within the various group fields.
4. The method of any of clauses 1-3, in which a first portion of the ID value identifies the programmable register, a second portion of the ID value identifies a group field in the programmable register, and a supervisor domain identification (SDID) identifies a domain field in the group field of the programmable register.
5. The method of clause 4, in which the domain field comprises a bit field, in which each bit directly indicates read access control, write access control, and execute control permissions of the supervisor domain corresponding to the SDID with a defined mapping between a bit position and the SDID.
6. The method of any of clauses 1-5, in which the set of programmable registers indicate read access control, write access control, and execute control permissions of the supervisor domains.
7. The method of any of clauses 1-6, in which the set of programmable registers is programmed to indicate read, write, and execute access control permission for each of the supervisor domains.
8. The method of any of clauses 1-7, in which the set of programmable registers is organized into different groups, each having multiple domains.
9. The method of any of clauses 1-8, in which the set of programmable registers comprise configuration status registers.
10. The method of any of clauses 1-9, in which the set of programmable registers are programmed by a root domain security manager (RDSM) application.
11. A non-transitory computer-readable medium having program code recorded thereon for enhanced unified memory protection table operation, the program code being executed by a processor and comprising:
   program code to perform, during physical memory access, a table walk to identify a leaf-node containing permissions for supervisor domains (SDs) corresponding to a physical memory address space;
   program code to access the leaf-node to determine an access control permissions field of the leaf-node; and
   program code to perform a look-up to determine access permissions for the supervisor domains from a set of programmable registers according to an identification (ID) value from the access control permissions field of the leaf-node.
12. The non-transitory computer-readable medium of clause 11, in which the leaf-node is enabled according to a memory protection table entry (MPTE) format.
13. The non-transitory computer-readable medium of any of clauses 11 or 12, in which the set of programmable registers is organized according to various group fields, and various domain fields within the various group fields.
14. The non-transitory computer-readable medium of any of clauses 11-13,in which a first portion of the ID value identifies the programmable register, a second portion of the ID value identifies a group field in the programmable register, and a supervisor domain identification (SDID) identifies a domain field in the group field of the programmable register.
15. The non-transitory computer-readable medium of clause 14, in which the domain field comprises a bit field, in which each bit directly indicates read access control, write access control, and execute control permissions of the supervisor domain corresponding to the SDID with a defined mapping between a bit position and the SDID.
16. The non-transitory computer-readable medium of any of clauses 11-15,in which the set of programmable registers indicate read access control, write access control, and execute control permissions of the supervisor domains.
17. The non-transitory computer-readable medium of any of clauses 11-16, in which the set of programmable registers is programmed to indicate read, write, and execute access control permission for each of the supervisor domains.
18. The non-transitory computer-readable medium of any of clauses 11-17, in which the set of programmable registers is organized into different groups, each having multiple domains.
19. The non-transitory computer-readable medium of any of clauses 11-18, in which the set of programmable registers comprise configuration status registers.
20. The non-transitory computer-readable medium of any of clauses 11-19, in which the set of programmable registers are programmed by a root domain security manager (RDSM) application.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed:

1. A method for enhanced unified memory protection table operation, the method comprising:
performing, during physical memory access, a table walk to identify a leaf-node containing permissions for supervisor domains (SDs) corresponding to a physical memory address space;
accessing the leaf-node to determine an access control permissions field of the leaf-node; and
performing a look-up to determine access permissions for the supervisor domains from a set of programmable registers according to an identification (ID) value from the access control permissions field of the leaf-node.

2. The method of claim 1, in which the leaf-node is enabled according to a memory protection table entry (MPTE) format.

3. The method of claim 1, in which the set of programmable registers are organized according to various group fields, and various domain fields within the various group fields.

4. The method of claim 1, in which a first portion of the ID value identifies the programmable register, a second portion of the ID value identifies a group field in the programmable register, and a supervisor domain identification (SDID) identifies a domain field in the group field of the programmable register.

5. The method of claim 4, in which the domain field comprises a bit field, in which each bit directly indicates read access control, write access control, and execute control permissions of the supervisor domain corresponding to the SDID with a defined mapping between a bit position and the SDID.

6. The method of claim 1, in which the set of programmable registers indicate read access control, write access control, and execute control permissions of the supervisor domains.

7. The method of claim 1, in which the set of programmable registers is programmed to indicate read, write, and execute access control permission for each of the supervisor domains.

8. The method of claim 1, in which the set of programmable registers is organized into different groups, each having multiple domains.

9. The method of claim 1, in which the set of programmable registers comprise configuration status registers.

10. The method of claim 1, in which the set of programmable registers are programmed by a root domain security manager (RDSM) application.

11. A non-transitory computer-readable medium having program code recorded thereon for enhanced unified memory protection table operation, the program code being executed by a processor and comprising:
program code to perform, during physical memory access, a table walk to identify a leaf-node containing permissions for supervisor domains (SDs) corresponding to a physical memory address space;
program code to access the leaf-node to determine an access control permissions field of the leaf-node; and
program code to perform a look-up to determine access permissions for the supervisor domains from a set of programmable registers according to an identification (ID) value from the access control permissions field of the leaf-node.

12. The non-transitory computer-readable medium of claim 11, in which the leaf-node is enabled according to a memory protection table entry (MPTE) format.

13. The non-transitory computer-readable medium of claim 11, in which the set of programmable registers is organized according to various group fields, and various domain fields within the various group fields.

14. The non-transitory computer-readable medium of claim 11, in which a first portion of the ID value identifies the programmable register, a second portion of the ID value identifies a group field in the programmable register, and a supervisor domain identification (SDID) identifies a domain field in the group field of the programmable register.

15. The non-transitory computer-readable medium of claim 14, in which the domain field comprises a bit field, in which each bit directly indicates read access control, write access control, and execute control permissions of the supervisor domain corresponding to the SDID with a defined mapping between a bit position and the SDID.

16. The non-transitory computer-readable medium of claim 11, in which the set of programmable registers indicate read access control, write access control, and execute control permissions of the supervisor domains.

17. The non-transitory computer-readable medium of claim 11, in which the set of programmable registers is programmed to indicate read, write, and execute access control permission for each of the supervisor domains.

18. The non-transitory computer-readable medium of claim 11, in which the set of programmable registers is organized into different groups, each having multiple domains.

19. The non-transitory computer-readable medium of claim 11, in which the set of programmable registers comprise configuration status registers.

20. The non-transitory computer-readable medium of claim 11, in which the set of programmable registers are programmed by a root domain security manager (RDSM) application.
